(19) United States
(12) Patent Application Publication
(10) Pub. No.: US 2026/0184347 A1
(43) Pub. Date: Jul. 2, 2026

(54) METHOD FOR PROTECTING LOST CARGO

(71) Applicant: Torc Robotics, Inc., Blacksburg, VA (US)

(72) Inventors: Pablo Smith, Spicewood, TX (US); Armenio Jose Rivero, Austin, TX (US); Akshay Pai Raikar, Austin, TX (US); William Gray Davis, Austin, TX (US)

(21) Appl. No.: 19/003,420

(22) Filed: Dec. 27, 2024

(51) Int. Cl. B60W 60/00; B60W 30/14; G05D 1/65; G05D 1/698; G05D 105/20; G05D 109/10; G06Q 10/0833

(52) U.S. Cl. CPC B60W 60/00256; B60W 30/146; B60W 60/0015; G05D 1/65; G05D 1/6985; G06Q 10/0833; B60W 2300/14; B60W 2556/45; G05D 2105/20; G05D 2109/10

(57) ABSTRACT

A method for protecting cargo with an autonomous vehicle is provided. The method includes detecting that a portion of the cargo has fallen out of the autonomous vehicle and designating the portion of the cargo has fallen out of the autonomous vehicle as lost cargo and the cargo still in the autonomous vehicle as remaining cargo. After detecting cargo has been lost the autonomous vehicle gathers one or more data points about the lost cargo using one or more sensors connected to the autonomous vehicle and transmits the one or more data points about the lost cargo to one or more third parties. The autonomous vehicle is then rerouted and navigates to the lost cargo and implements traffic safety measures.

### TECHNICAL FIELD

The field of the disclosure relates to methods of operation of an autonomous vehicle to protect lost cargo. In particular, to a method of identifying, reporting, and protecting lost cargo that has fallen out of an autonomous vehicle during transit.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Autonomous vehicles, such as autonomous tractor trailers, are deployed and expected to transport cargo across long distances and in sometimes remote locations. During transit the cargo may become unsecured, for example the doors of the trailer may not have been properly secured before departure and open while the autonomous vehicle is in transit. Additionally, cargo that has fallen out of a trailer onto the road poses a safety risk to other drivers. In conventional non-autonomous vehicle situations a driver may pullover and manually close the trailer doors and either clear the cargo from the roadway or alert the proper authorities, for example State Departments of Transportation or local emergency services; however, an autonomous vehicle does not have a driver who can manually perform these actions. Instead, the autonomous vehicle must balance securing the cargo, both the cargo that has been lost and the cargo remaining in the vehicle and completing the delivery. If the autonomous vehicle decides to continue the trip to the destination, there is a risk that cargo will fall out of the trailer resulting in a failed delivery and endangering other vehicles. If the autonomous vehicle decides to pullover and wait for service personnel to arrive, there may be significant delivery delays, especially if the autonomous vehicle is in a remote location, and the cargo is left exposed, being susceptible to theft or the elements.

Additionally, when lost cargo is obstructing the roadway, emergency services or highway patrol are contacted to block off or clear the roadway. However, there is a delay between the cargo being lost and the proper authorities being notified and in the response time in blocking off or clearing the roadway. During this time there is an increased safety risk to other drivers as well as the risk that the lost cargo may be damaged.

Accordingly, there exists a need for a method for proactively identifying, reporting, and protecting lost cargo which is able to be used in combination with modified autonomous vehicle driving behaviors to protect lost cargo.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, a method for protecting cargo with an autonomous vehicle is provided. The method includes detecting that a portion of the cargo has fallen out of the autonomous vehicle and designating the portion of the cargo has fallen out of the autonomous vehicle as lost cargo and the cargo still in the autonomous vehicle as remaining cargo. The autonomous vehicle then gathers one or more data points about the lost cargo using one or more sensors connected to the autonomous vehicle and transmits the one or more data points about the lost cargo to one or more third parties. The autonomous vehicle is then rerouted and navigates to the lost cargo. After the autonomous vehicle navigates to the lost cargo, the autonomous vehicle implements one or more traffic safety measures to protect the lost cargo.

In another aspect, a method for operating a lead autonomous vehicle and a follow up autonomous vehicle for protecting cargo is provided. The method includes detecting that a portion of the cargo has fallen out of the lead autonomous vehicle and designating the portion of the cargo has fallen out of the lead autonomous vehicle as lost cargo and the cargo still in the lead autonomous vehicle as remaining cargo. The lead autonomous vehicle then gathers initial data points about the lost cargo using one or more sensors connected to the lead autonomous vehicle and transmits the initial data points about the lost cargo to one or more third parties and the follow up autonomous vehicle. The lead autonomous vehicle is then rerouted and navigates to a secure location. The method further includes transmitting a request to the follow up autonomous vehicle to protect the lost cargo and rerouting and navigating the follow up autonomous vehicle to the lost cargo. After the follow up autonomous vehicle navigates to the lost cargo, the follow up autonomous vehicle implements one or more traffic safety measures.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic view of an autonomous truck;

FIG. 2 is a schematic view of an autonomous truck with an attached trailer;

FIG. 3 is a side schematic view of the autonomous truck shown in FIG. 2;

FIG. 4 is a block diagram of the autonomous truck shown in FIG. 1;

FIG. 5 is a block diagram of an example computing system;

FIG. 6 is a flow chart of a method of operation of an autonomous vehicle to protect lost cargo;

FIG. 7 is a flow chart of a method of operation of a lead autonomous vehicle and a follow up autonomous vehicle to protect lost cargo;

FIG. 8 is a schematic view of a roadway scenario of an autonomous vehicle that has lost cargo;

FIG. 9 is a schematic view of a roadway scenario of autonomous vehicle protecting lost cargo;

FIG. 10 is a schematic view of a roadway scenario of a follow up autonomous vehicle passes by the lost cargo;

FIG. 11 is a schematic view of a trailer with a lost cargo prevention system in a retracted position;

FIG. 12 is a schematic view of a trailer with a lost cargo prevention system in a partially deployed position;

FIG. 13 is a schematic view of a trailer with a lost cargo prevention system in a fully deployed position;

FIGS. 14A-C are schematic views of various net configurations;

FIG. 15 is an internal side view schematic view of a trailer with a lost cargo prevention system in a bay door style retracted position;

FIG. 16 is an internal side view schematic view of a trailer with a lost cargo prevention system in an accordion style retracted position;

FIG. 17 is a schematic view of a trailer with a lost cargo prevention system in a partially deployed position;

FIG. 18 is a schematic view of a trailer with a lost cargo prevention system in a fully deployed position;

FIG. 19 is an internal side view schematic view of a trailer with a lost cargo prevention system in a compartment style retracted position; and

FIG. 20 is a flow chart of a method of operation of an autonomous vehicle with a lost cargo prevention cargo system.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

As described herein, systems and methods for lost cargo prevention are provided. The lost cargo prevention system may be installed in a trailer or storage container. The lost cargo prevention system may have a net movable between a retracted position and a deployed position, the net being suspended between opposing guide rails on the interior sides of the trailer or storage container. An edge of the net may be fixed relative to the trailer or storage container such that when an opposing edge of the net is moved the net is moved between the retracted and deployed position. When in the deployed position, net covers or substantially covers an open end of the trailer or storage container to prevent cargo from falling out.

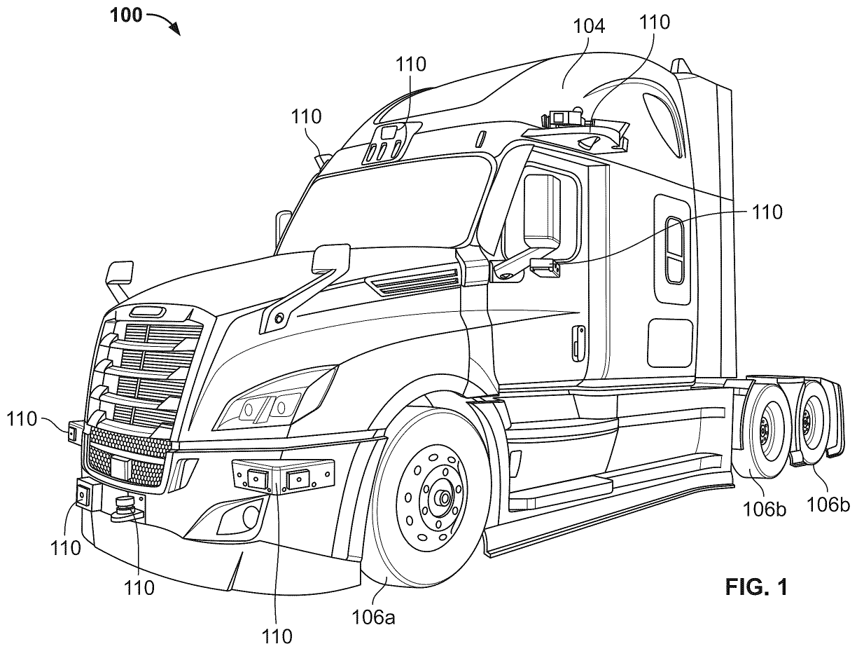

Various embodiments in the present disclosure are described with reference to FIGS. 1-20 below.

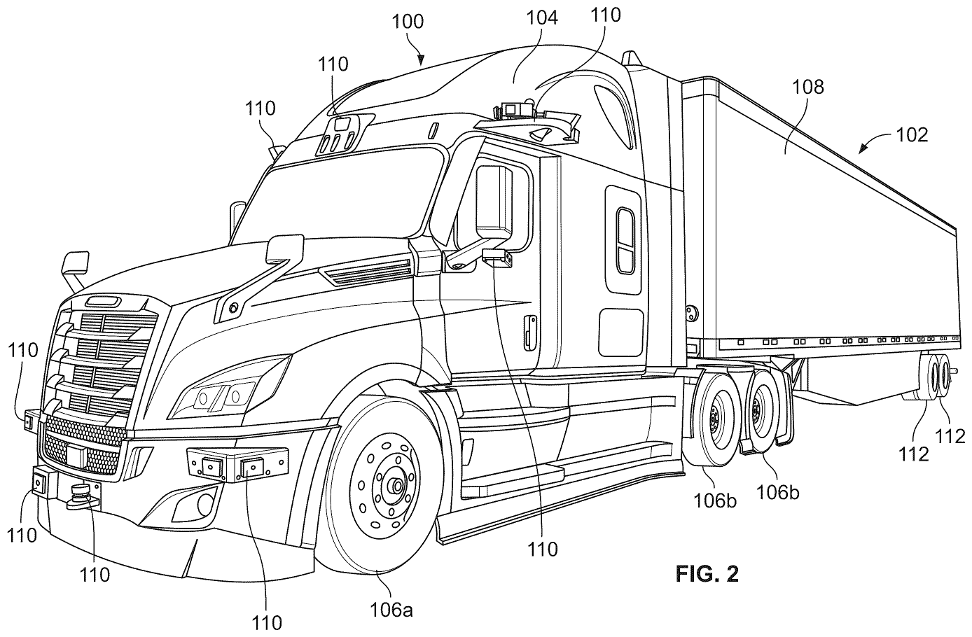

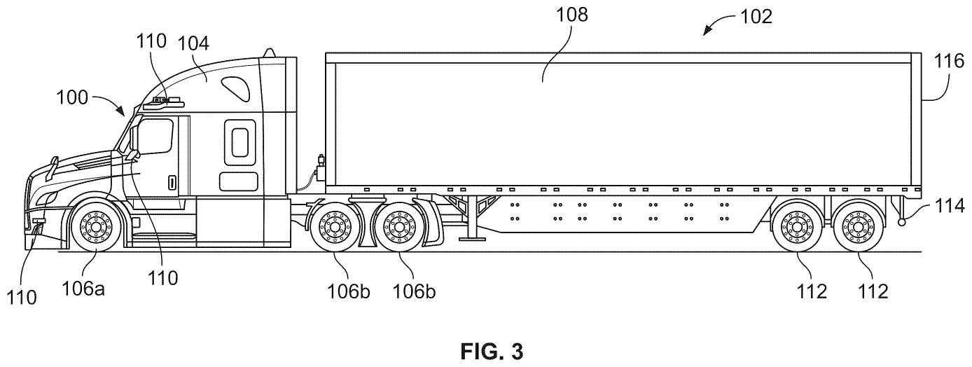

FIG. 1 is a perspective view of a vehicle 100, such as a truck that may be conventionally connected to a single or tandem trailer 102 to transport the trailer 102 to a desired location, as shown in FIGS. 2 and 3, which are, respectively, perspective and side views of the vehicle 100 of FIG. 1 with the trailer 102 attached thereto. Vehicle 100 includes a cabin 104 that can be supported, and steered in the required direction, by front wheels 106a and rear wheels 106b which are partially shown in FIG. 1. The front wheels 106a are positioned by a steering system that includes a steering wheel and a steering column (not shown). The steering wheel and the steering column may be located in the interior of cabin 104.

The vehicle 100 may be an autonomous vehicle, in which case the vehicle 100 may omit the steering wheel and the steering column to steer the vehicle 100. Rather, the vehicle 100 may be operated by an autonomy computing system of the vehicle 100 based on data collected by a sensor network including one or more sensors, e.g., sensors 110 shown in FIGS. 1-3. The vehicle 100 may additionally include a fifth-wheel coupling (not shown) to which the trailer 102 can be releaseably attached. The trailer 102 can include a storage container 108, a plurality of rear wheels 112 that support the storage container 108, and an underride guard 114. The trailer 102 can have doors 116 providing access to the interior of the trailer 102. It should be understood that in some embodiments the vehicle 100 and the trailer 102 can be permanently attached as a single unit.

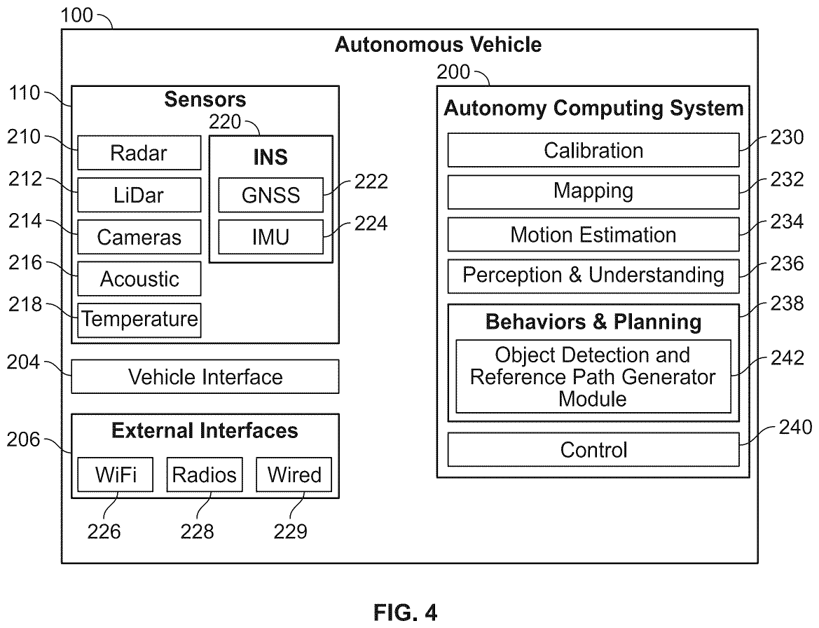

FIG. 4 is a block diagram of autonomous vehicle 100 shown in FIG. 1. In the example embodiment, autonomous vehicle 100 includes autonomy computing system 200, sensors 110, a vehicle interface 204, and external interfaces 206.

In the example embodiment, sensors 110 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 110 not shown in FIG. 2 may include, for example, acoustic (e.g., ultrasound), internal vehicle sensors, meteorological sensors, or other types of sensors. Sensors 110 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers in the environment surrounding autonomous vehicle 100. In some embodiments, the image data generated by cameras 214 may be sent to autonomy computing system 200 or other aspects of autonomous vehicle 100 for one or more of identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

In some embodiments, the image data generated by cameras 214 may be transmitted to mission control for one or more of identifying one or more construction markers (or nodes), generating one or more connectivity graphs based upon identified construction markers (or nodes), updating a reference path based upon the one or more connectivity graphs, transmitting the updated reference path to the autonomy vehicle 100 for guiding autonomous vehicle 100 to drive on the updated reference path.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 110 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 229, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 110. These modules may include, for example, a calibration module 230, a mapping module 232, a motion estimation module 234, a perception and understanding module 236, a behaviors and planning module 238, a control module or controller 240, and an object detection and reference path generator module 242. The object detection and reference path generator module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The object detection and reference path generator module 242 may perform one or more tasks including, but not limited to, identifying one or more construction markers (or nodes), generating one or more connectivity graphs based upon identified construction markers (or nodes), updating a reference path based upon the one or more connectivity graphs, transmitting the updated reference path to other modules of the autonomy computing system 200 or mission control or both.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

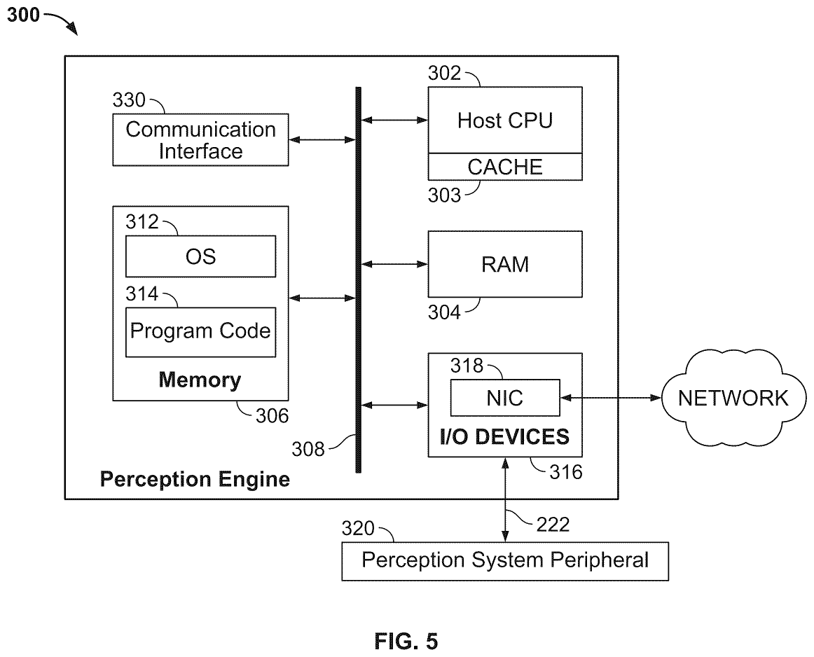

FIG. 5 is a block diagram of an example computing system 300, such as the autonomy computing system 200 shown in FIG. 4, configured for sensing an environment in which an autonomous vehicle is positioned. Computing system 300 includes a CPU 302 coupled to a cache memory 303 and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 4. In alternative embodiments, one or more sections of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a perception system peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, or a CAN bus controller for communicating over a CAN bus.

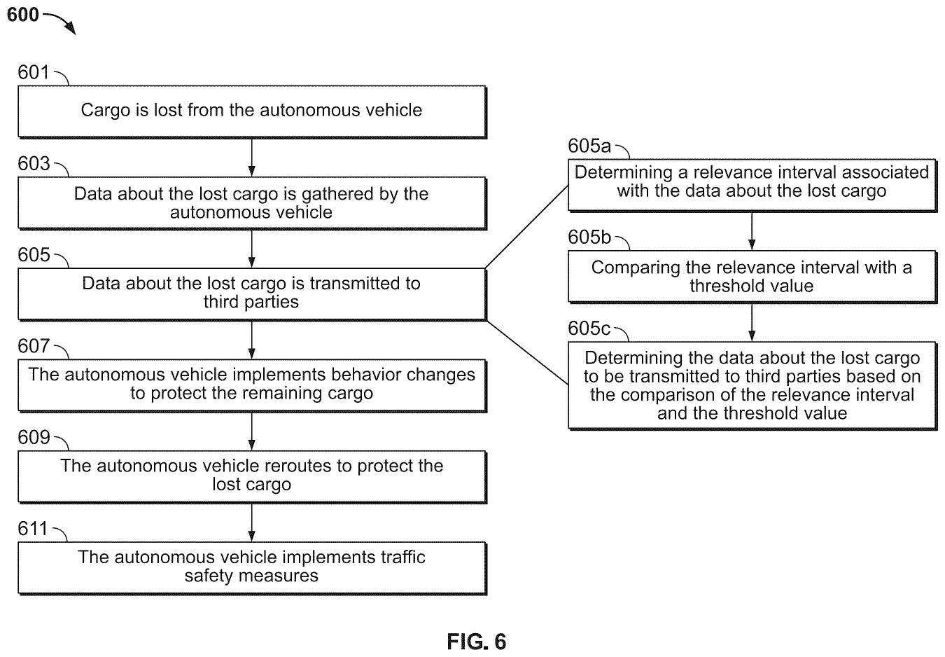

FIG. 6 is a flow chart of a method 600 for operation of an autonomous vehicle 100 when the autonomous vehicle 100 detects that cargo has been lost according to some embodiments. At 601 cargo that is being transported by an autonomous vehicle 100 is lost, for example boxes or crates falling out of the back of the trailer 102. The autonomous vehicle 100 may detect that cargo has been lost using a variety of methods. For example, a location module secured to a piece of cargo geo-fenced to the autonomous vehicle 100, a sensor 110, for example a rear facing camera 214, mounted on the trailer 102 detecting the lost cargo, or the perception and understanding module 236 detecting a change in the center of mass of the trailer 102, a change in the speed of the autonomous vehicle 100, or a change in the momentum of the autonomous vehicle 100, although not limited thereto. The cargo that has fallen out of the trailer 102 may be designated as lost cargo and the cargo remaining in the trailer 102 may be designated as remaining cargo. In some embodiments, the perception and understanding module 236 uses one or more of the aforementioned factors in combination when determining if cargo is lost.

After the autonomous vehicle 100 has determined that the cargo has been lost, at 603 the autonomous vehicle 100 begins gathering data about the lost cargo using the sensors 110 and accessing predetermined data about the cargo stored on a database, for example, the memory 306 The data associated with the lost cargo may include the date and time the cargo was lost, the GPS position of the autonomous vehicle 100 when the cargo was lost, and the GPS position of the lost cargo, and the relative position data. The relative position data may comprise and is not intended to be limited to data collected by a rear facing camera 214 for example. The data may indicate whether any or all of the lost cargo is in the middle of the road or off to the side on the shoulder, the size of the last cargo, the quantity of the lost cargo (the number of packages lost), and information about the contents of the lost cargo, although not limited thereto. The information about the contents of the lost cargo may include potential hazards associated with the cargo, for example whether the cargo included produce which may attract animals towards the roadway, chemicals that pose an environmental risk, or materials that pose an increased risk to other vehicles on the roadway, for example if the cargo included sharp object which may puncture tires, the value of the cargo, and whether the lost cargo is prone to theft. In some embodiments, the data about the lost cargo may also include current ambient conditions and anticipated future ambient conditions, for example the weather, visibility, road conditions, and traffic conditions, although not limited thereto.

At 605, the data about the lost cargo is transmitted to one or more third parties. The third parties may include a fleet commander or control center of the autonomous vehicle 100, local law enforcement, State Departments of Transportation, the shipper and intended recipient of the cargo, other autonomous vehicles 100 in the fleet, and autonomous vehicles 100 not in the fleet. Communication with the third parties may be carried out using the external interfaces 206 and vehicle to vehicle (V2V) communication protocols.

In some embodiments, the communication with third parties may be broken down into: 605a: determining a relevance interval associated with the data about the lost cargo, 605b: comparing the relevance interval with a threshold value, and 605c: determining what data to transmit to each of the one or more third parties. At 605a, the autonomy computing system 200, for example the perception and understanding module 236, may be used to evaluate each of the data points about the lost cargo and determine a relevance interval of the data for each of the third parties. For example, data points such as the GPS location and time the cargo was lost may be relevant to State Departments of Transportation and local law enforcement, whereas the value of the lost cargo may not be relevant to State Departments of Transportation but may be relevant to local law enforcement. However, if the value of the lost cargo is low it may still not be relevant to local law enforcement.

At 605b the relevance interval is compared against a threshold value associated with each third party. For example, a fleet commander of the autonomous vehicle 100 may have a low or zero threshold value since the fleet commander may want to receive and log all data available related to the lost cargo, whereas other autonomous vehicles 100 may have a high threshold value to avoid receiving superfluous data. Based on the comparison of the relevance interval for each the data point about the lost cargo and the threshold value for a particular third party, at 605c, the autonomy computing system 200 determines what data about the lost cargo to transmit to the particular third party. In this way the autonomous vehicle 100 and the autonomy computing system 200 can limit sending irrelevant or unwanted data to the third parties.

Although the discussion of the relevancy interval for particular data points and the threshold value for individual third parties is made in relation with specific examples, it is appreciated that various factors may be used when determining the relevancy interval and the threshold value. In some embodiments, the relevancy interval and the threshold value are based on feedback on historic data transmissions from the third parties. For example, local law enforcement and State Departments of Transportation may request that certain data points be transmitted or withheld, e.g., while ambient weather data may be relevant, the third parties have access to this information through different means, and it is superfluous for the autonomous vehicle 100 to transmit this data. In some embodiments, the data to be transmitted may be required by local statute or ordinance. In some embodiments, the fleet commander may work with individual third parties to determine a specific relevancy interval or threshold value for that third party.

At 607, the autonomous vehicle 100 may implement operation behavior changes to protect the remaining cargo. Since cargo has been lost, there is higher likelihood that additional cargo may be lost. For example, the back of the trailer 102 may be open leaving the remaining cargo prone to being lost. To reduce the risk of losing additional cargo, the behavior and planning module 238 may reduce the speed and acceleration changes of the autonomous vehicle 100 and may reroute the autonomous vehicle 100 to avoid steep or winding roads, for example roads with a gradient or a curvature above an acceptable threshold. In some embodiments, the autonomous vehicle 100 may pullover and stop on the side of the road. In some embodiments, the suspension in the rear wheels 106b may be released to tilt the trailer 102 toward the cabin 104. In some embodiments, the autonomous vehicle 100, depending on the surrounding conditions, may make a sudden stop to shift the cargo to the back of the trailer 102 before continuing forward.

At 609, the autonomous vehicle 100 may reroute back to the position of the lost cargo. Once the autonomous vehicle 100 has returned to the lost cargo, the object detection and reference path generator module 242 may detect the lost cargo and navigate the autonomous vehicle 100 behind the lost cargo. Once in position near the lost cargo, at 611, the autonomous vehicle 100 may implement traffic safety measures, for example deploying safety cones, turning on the vehicle hazards, and angling the autonomous vehicle 100 and the trailer 102 to direct traffic away from the lost cargo.

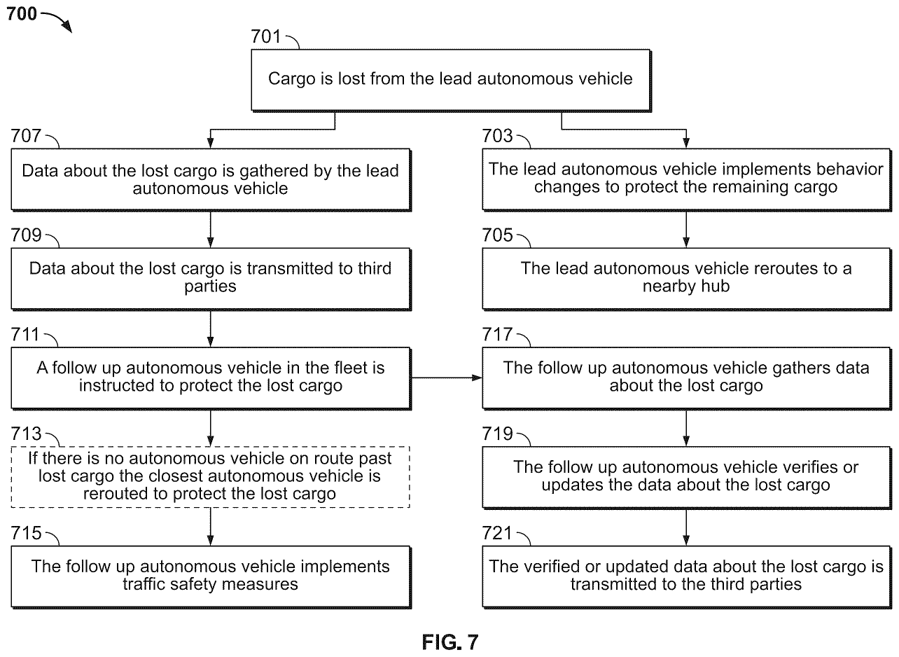

FIG. 7 is a flow chart of a method 700 for operation of a lead autonomous vehicle 100 and a follow up autonomous vehicle 100′, when the lead autonomous vehicle 100 detects that cargo has been lost according to some embodiments. The method 700 illustrates an embodiment whereby the lead autonomous vehicle 100 detects at least some of the cargo being transported is lost and it is desirable for a follow up autonomous vehicle 100′ to protect the cargo. For example, the lead autonomous vehicle 100 may have unsecured cargo, the nearby roads may limit the feasibility of having lead autonomous vehicle 100 circle back to protect the lost cargo (e.g., the next available exit is far away or bridge height restrictions limit rerouting options), the follow up autonomous vehicle 100′ is nearby and already routing past the location the cargo was lost, or a combination thereof. The lead autonomous vehicle 100 and the follow up autonomous vehicle 100′ may be the same or substantially similar to each other, with the lead autonomous vehicle 100 having lost some of the cargo being transported. It is appreciated that the terms lead and follow up are used to differentiate the lead autonomous vehicle 100 and the follow up autonomous vehicle 100′ from each other and is not intended to limit the function or relative position thereof.

At 701, cargo that is being transported by a lead autonomous vehicle 100 is lost, for example boxes or crates falling out of the back of the trailer 102. Using a variety of methods, the lead autonomous vehicle 100 may detect that cargo has been lost. For example, the loss of cargo may be detected by using any of the following methods/systems/modules, but it is not limited to: a location module secured to a piece of cargo geo-fenced to the lead autonomous vehicle 100, a sensor 110, for example a rear facing camera 214, mounted on the trailer 102 detecting the lost cargo or the perception and understanding module 236 detecting a change in the center of mass of the trailer 102, a change in the speed of the lead autonomous vehicle 100, or a change in the momentum of the lead autonomous vehicle 100. In some embodiments, the perception and understanding module 236 uses one or more of the aforementioned factors when determining if cargo is lost.

At 703, the lead autonomous vehicle 100 may implement operation behavior changes to protect the remaining cargo. Since cargo has already been lost, there is a higher likelihood that additional cargo may be lost. For example, the back of the trailer 102 may be open leaving the remaining cargo prone to being lost. To reduce the risk of losing additional cargo, the behavior and planning module 238 may reduce the speed and acceleration changes of the lead autonomous vehicle 100, and may reroute the autonomous vehicle to avoid steep or winding roads. In some embodiments, the lead autonomous vehicle 100 may pull over and stop on the side of the road. In some embodiments, the suspension in the rear wheels 106b may be released to tilt the trailer 102 toward the cabin 104. In some embodiments, the lead autonomous vehicle 100, depending on the surrounding conditions, may make a sudden stop to shift the cargo to the back of the trailer 102 before continuing forward.

At 705 the lead autonomous vehicle 100 may be rerouted to a nearby hub or other secure destination. Depending on the content of the cargo and the location of the lead autonomous vehicle, it may be desirable to reroute the lead autonomous vehicle 100 to a secondary location rather than continuing to the destination with the behavior changes implemented at 703. For example, environmental or road conditions may prevent the lead autonomous vehicle 100 from operating safely even with the implemented behavior changes or the unsecured trailer 102 may pose an increased risk, e.g., driving though areas with a high crime rate.

In some embodiments, the lead autonomous vehicle 100 may reroute to an intermediary shipping hub where the cargo and the trailer 102 may be re-secured before continuing to the destination. In some embodiments, a third-party location such as a rest stop or a police station may be coordinated as a secure location until service personnel can be dispatched to re-secure the cargo and the trailer 102. In some embodiments, the lead autonomous vehicle 100 may detach the trailer 102 and continue to receive a new load while service personnel are dispatched to secure the cargo and trailer 102.

As with the method 600, in method 700 relating to lost cargo from a lead autonomous vehicle, after the lead autonomous vehicle 100 has determined that the cargo has been lost, at 707 the lead autonomous vehicle 100 begins gathering data about the lost cargo using the sensors 110 and predetermined data about the cargo. The data about the lost cargo may include the date and time the cargo was lost, the GPS position of the autonomous vehicle 100 when the cargo was lost and the GPS position of the lost cargo, relative position data, for example, a rear-facing camera 214 seeing if the lost cargo is in the middle of the road or off to the side on the shoulder, and information about the contents of the lost cargo, although not limited thereto. The information relating to the contents of the lost cargo may include potential hazards associated with the cargo, for example, whether the cargo included produce that may attract animals towards the roadway, chemicals that pose an environmental risk, or materials that pose an increased risk to other vehicles on the roadway, the value of the cargo, and whether the lost cargo is prone to theft. In some embodiments, the data relating to the lost cargo may also include ambient conditions and anticipated future conditions, for example the weather, visibility, road conditions, and traffic conditions, although not limited thereto.

At 709, the data relating to the lost cargo is transmitted to one or more third parties. The third parties may include a fleet commander or control center of the lead autonomous vehicle 100, local law enforcement and State Departments of Transportation, the shipper and intended recipient of the cargo, other autonomous vehicles 100 in the fleet, and autonomous vehicles 100 not in the fleet. Communication with third parties may be carried out via the external interfaces 206 and vehicle-to-vehicle (V2V) communication protocols.

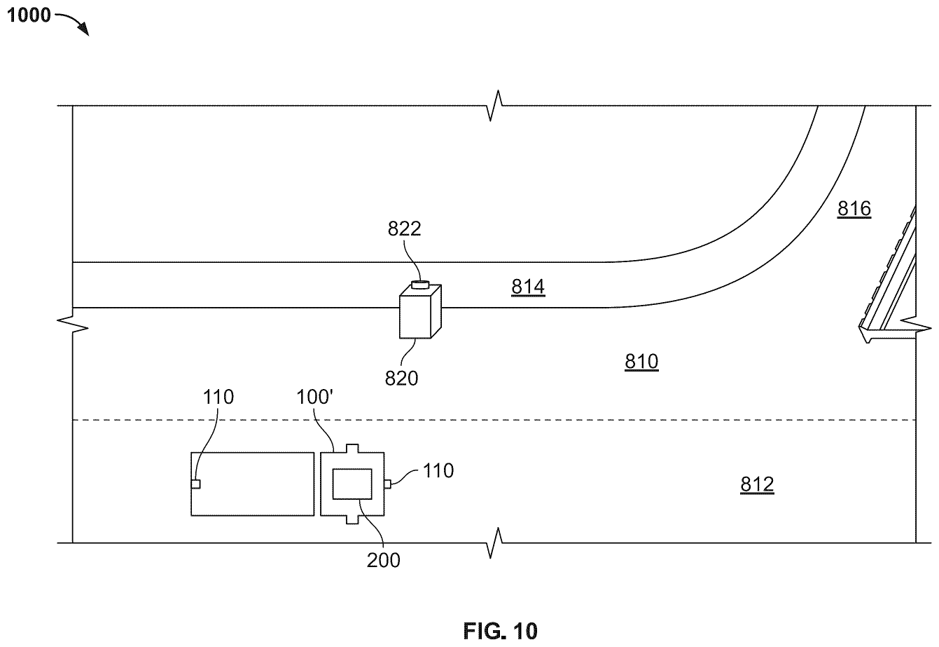

At 711, a follow up autonomous vehicle 100′, shown in FIG. 10, is instructed to protect the lost cargo. In some embodiments, the lead autonomous vehicle 100 sends a request directly to the follow up autonomous vehicle 100′ using V2V communication protocols. In some embodiments, a fleet commander will send a request to the follow up autonomous vehicle 100′ to protect the lost cargo. In some embodiments, it may be desirable to have a follow up autonomous vehicle 100′ protect the lost cargo as opposed to having the lead autonomous vehicle 100 protect the cargo because the lead autonomous vehicle 100 has an unsecured cargo in the associated trailer 102.

If there is no autonomous vehicle which is currently routed to pass by the lost cargo or which is a significant distance from the lost cargo, at 713, a nearby autonomous vehicle may be identified and rerouted to protect the lost cargo. In some embodiments, the follow up autonomous vehicle 100′ may deny the request to protect the lost cargo, for example the follow up autonomous vehicle 100′ have a time sensitive delivery to complete or may not be equipped to protect the lost cargo. In such embodiments, subsequent requests to other nearby autonomous vehicles may be made until the request is accepted or there are no nearby autonomous vehicles available. Once the follow-up autonomous vehicle 100′ approaches the lost cargo, at 715, the follow-up autonomous vehicle 100′ may implement traffic safety measures, for example deploying safety cones, turning on the vehicle hazards, and angling the vehicle and the trailer 102 to direct traffic away from the lost cargo.

At 717, as the follow up autonomous vehicle 100′ approaches the lost cargo, the follow up autonomous vehicle 100′ undertakes a similar procedure completed by the lead autonomous vehicle 100 at 707, gathering data about the lost cargo. For example, the follow up autonomous vehicle 100′ may record the GPS position and relative position of the lost cargo with a new time and date stamp. At 719, the follow up autonomous vehicle 100′ will verify or update the data previously transmitted by the lead autonomous vehicle 100. For example, the follow up autonomous vehicle 100′ may verify that the lost cargo is still in the previously reported GPS position by comparing the initial data about the lost cargo gathered by the lead autonomous vehicle 100 to the follow up data gathered by the follow up autonomous vehicle 100′. Further, the follow up autonomous vehicle 100′ may find that the lost cargo has been moved to the side of the road and update the initial relative position data of the lost cargo to reflect the change in position. In some embodiments, the verification may be confirmation that the follow up autonomous vehicle 100′ recorded the same data as the lead autonomous vehicle 100 and the update may be a change between the initial data about the lost cargo gathered by the autonomous vehicle 100 and the follow up data about the lost cargo gathered by the follow up autonomous vehicle 100′. The verified and updated data may be transmitted to third parties at 721. In some embodiments, the verified and updated data may be given a timestamp of when the data was verified or updated and an indicator that the data was verified or updated by the follow up autonomous vehicle 100′. The verification process may also add a layer of redundancy and confidence, positively confirming that the lead autonomous vehicle 100 did lose cargo, thereby reducing false positives.

In some embodiments, the follow up autonomous vehicle 100′ will pass the location of the lost cargo and as the vehicle 100′ passes the lost cargo, gather data about the lost cargo at 717, verify or update the data about the lost cargo at 719, and transmit the verified or updated data about the lost cargo to the third parties at 721, without stopping to protect the lost cargo. For example, the follow up autonomous vehicle 100′ may not be equipped or able to stop and protect the cargo. In such situations the follow up autonomous vehicle 100′ may still collect data about the lost cargo while passing by, verifying and updating the data about the lost cargo previously gathered and transmitted by the lead autonomous vehicle 100, and transmitting the verified and updated data about the lost cargo to third parties.

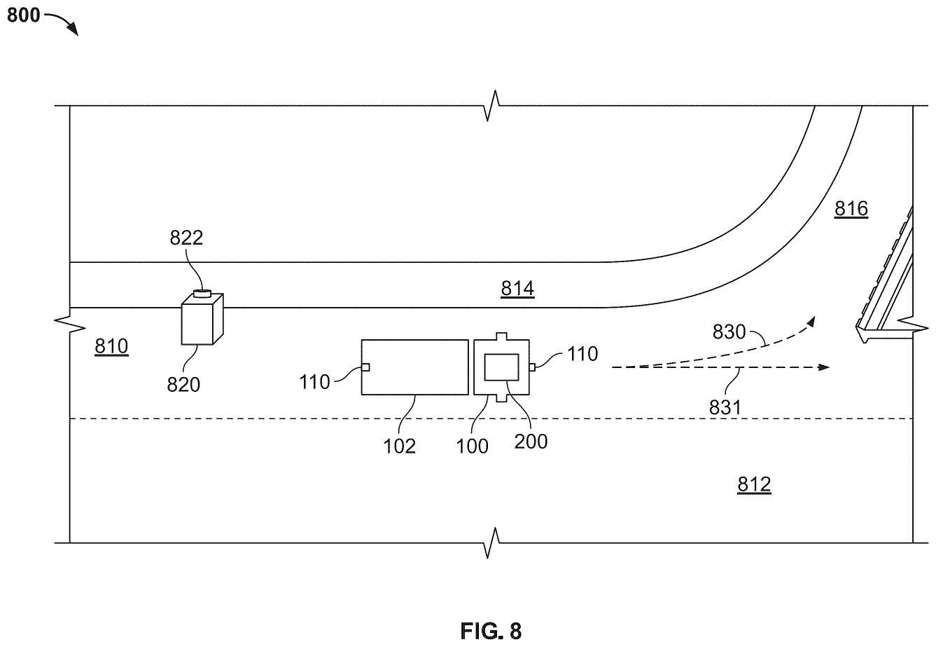

FIG. 8 is a bird's eye view of a roadway scenario 800 including a schematic representation of a lead autonomous vehicle 100 and a piece of lost cargo 820. Roadway scenario 800 includes a two-lane roadway with a first lane 810 and a second lane 812, a bike lane/sidewalk 814 adjacent the first lane 810, and an exit lane or ramp 816 exiting from the first lane 810. The lead autonomous vehicle 100 is traveling in the first lane 810 and contains an autonomy computing system 200 and sensors 110 configured to detect target objects in a region around the lead autonomous vehicle 100.

In roadway scenario 800, a piece of lost cargo 820 has fallen out of the back of the trailer 102 of the lead autonomous vehicle 100 and is located so that the lost cargo 820 is partially located in the first lane 810 and on the sidewalk 814. A GPS module 822 on the lost cargo 820 is geo-fenced to the lead autonomous vehicle 100, and once the distance between the GPS module 822 and the lead autonomous vehicle 100 exceeds a certain threshold, the lead autonomous vehicle 100 is alerted that the lost cargo 820 has fallen out of the trailer 102. The sensors 110 then begin gathering data about the lost cargo 820. For example, the data may comprise GPS position and the relative position of the lost cargo 820. The lead autonomous vehicle 100 may take path 830 to the exit ramp 816 to circle return to the location of the lost cargo 820 and protect the lost cargo 820. Alternatively, the vehicle 100 may follow direction identified by arrow 831 and continue in the first lane 810 to its destination.

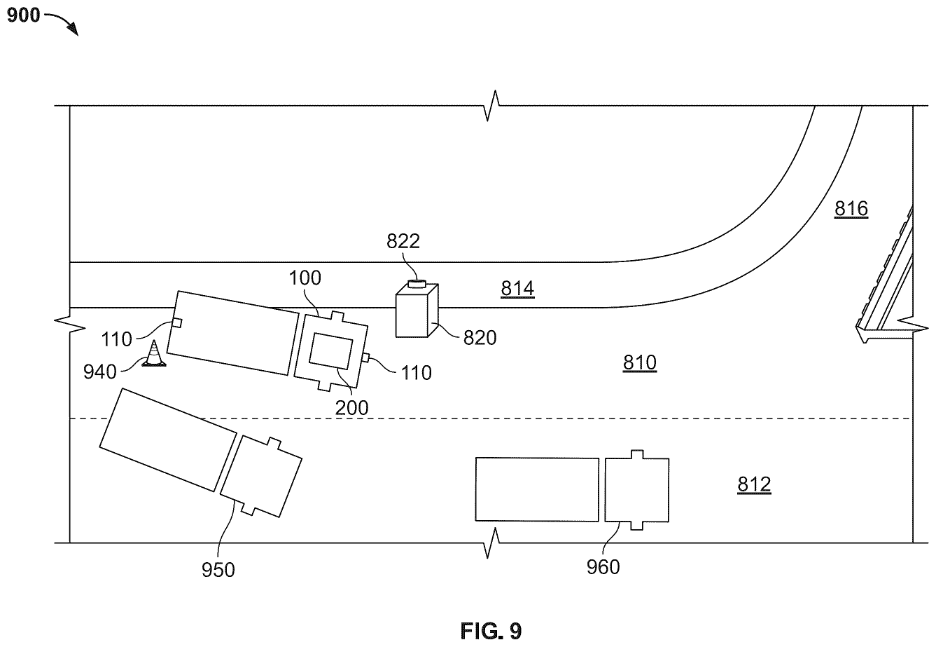

FIG. 9 is a bird's eye view of a roadway scenario 900 including a schematic representation of a lead autonomous vehicle 100 protecting a piece of lost cargo 820. In FIG. 9, the lead autonomous vehicle 100 has rerouted back around to the piece of lost cargo 820 and has implemented traffic safety measures to protect the lost cargo 820. For example, in FIG. 9, the lead autonomous vehicle 100 has deployed a traffic cone 940 and stopped at an angle relative to the direction traffic would move along lane 810. As a result of this maneuver, traffic is diverted from the first lane 810 to the second lane 812. The other vehicles 950, 960 are able to merge into the second lane 812 and continue on the roadway without damaging the lost cargo 820. In scenarios with a single lane road or lanes with opposing traffic, the other vehicles 950, 960 can navigate the roadway in an alternating feed similar to when there is a vehicle double parked. In some embodiments of the roadway scenario 900, the lead autonomous vehicle 100 may be replaced by a follow up autonomous vehicle 100′ which was already routing past the lost cargo 820 or was rerouted past the lost cargo 820.

FIG. 10 is a bird's eye view of a roadway scenario 1000 including a schematic representation of a follow up autonomous vehicle 100′ gathering data about the lost cargo 820 while passing by the lost cargo. In the scenario depicted in FIG. 10, the follow up autonomous vehicle 100′ is not able or equipped to stop and protect the lost cargo 820. As the follow up autonomous vehicle 100′ passes by the lost cargo 820, the sensors 110 on the follow up autonomous vehicle 100′ gather data about the lost cargo 820, for example the GPS position and the relative position of the lost cargo 820. The data gathered by the follow up autonomous vehicle 100′ may be used to verify and update data previously gathered about the lost cargo 820.

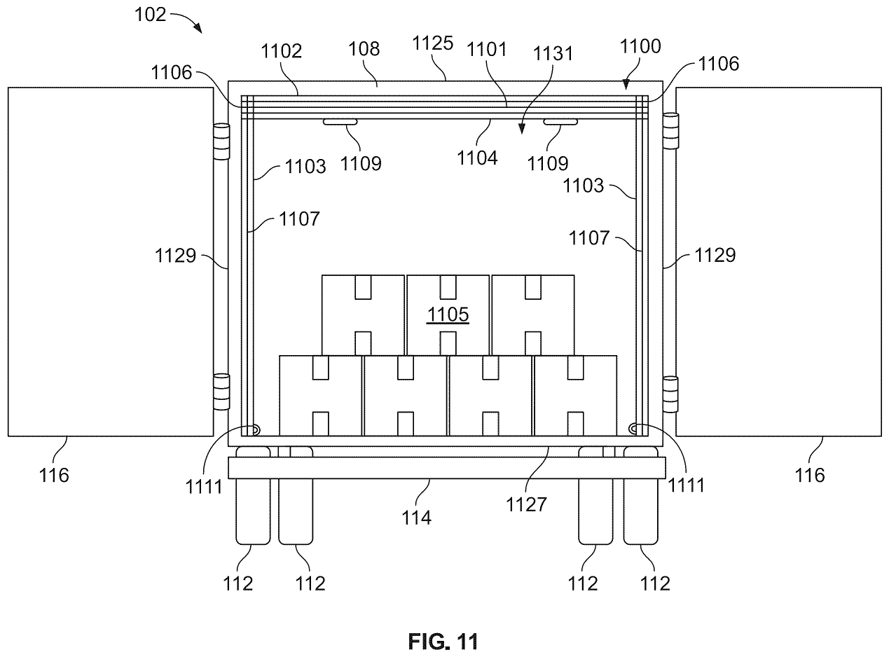

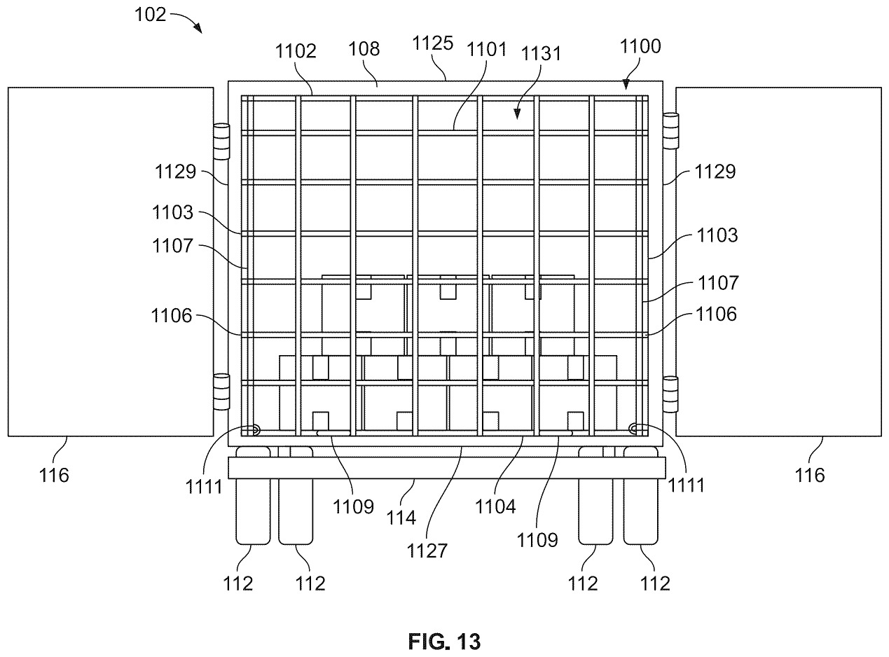

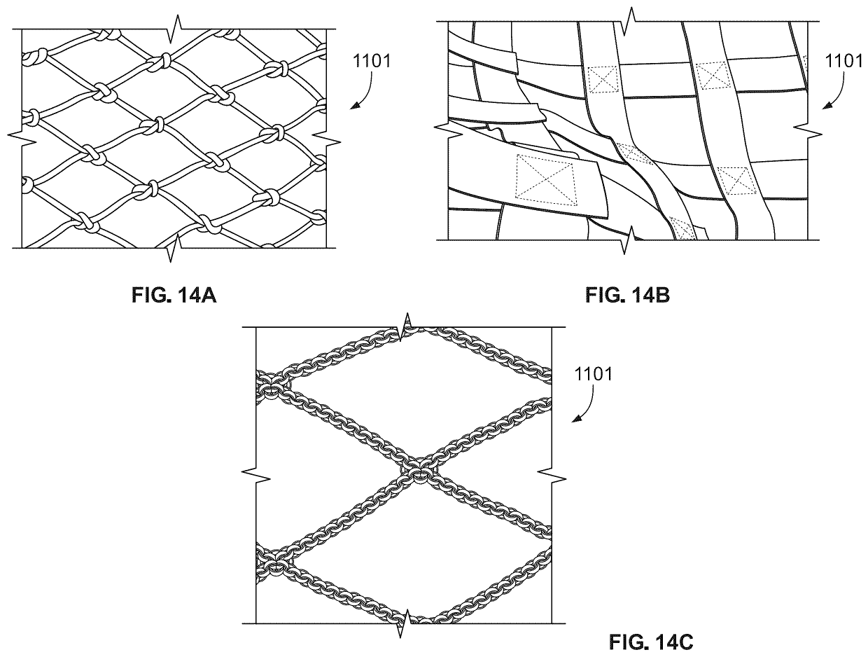

FIG. 11 is the back of a trailer 102 with a lost cargo prevention system 1100 in a retracted position, according to some embodiments. The lost cargo prevention system 1100 may be installed in the interior of trailer 102 in storage container 108 and may include a deployable cargo impeding member, for example net 1101, retained on ceiling 1125 of trailer 102 and guide rails 1103 on opposing side walls 1129 of trailer 102. Ceiling 1125, floor 1127, and opposing side walls 1129 of trailer 102 define storage container 108. Net 1101 may be suspended between guide rails 1103 and may be operatively engaged with guide rails 1103. Guide rails 1103 may extend vertically, between ceiling 1125 and floor 1127 of trailer 102 and are located proximate open trailer end 1131. Guide rails 1103 serve as a track or guide for net 1101. Guide rails 1103 are configured to receive opposing peripheral portions 1106 of net 1101, and serve to guide the movement of net 1101 between a deployed orientation or position where net 1101 extends across the open trailer end 1131, FIG. 13, and a retracted orientation or position where net 1101 is raised and gathered proximate ceiling 1125 of trailer 102, FIG. 11. Net 1101 may be made of any flexible and durable material, for example, steel cabling, Dyneema, Kevlar, nylon, polyethylene, or metal chains, although not limited thereto. The type of material used to form net 1101 may depend on cargo 1105 being transported. For example, it may be desirable to use steel cabling when transporting heavy cargo whereas a nylon rope net may be suitable for use when transporting light weight packages. In some embodiments net 1101 may be a braided net with individual ropes of net 1101 being knotted/tied together to form a lattice (shown in FIG. 14A), a strap net with individual straps of net 1101 being overlaid and sewn together, similar to a cargo net (shown in FIG. 14B), or a woven net whereby the threads of the rope forming net 1101 are woven together (shown in FIG. 14C). In some embodiments, net 1101 is replaceable and may be switched out for a different net 1101 depending on cargo 1105 being transported or if net 1101 becomes damaged. Although the embodiments discussed herein make reference to net 1101, it is understood that net 1101 may be replaced or supplemented by another cargo impeding member, for example connected bars, sheets forming a lattice, bay doors, a flexible corrugated metal sheet, or other configuration which is movable between a retracted position and a deployed position covering open trailer end 1131.

In some embodiments, net 1101 may be desirable to secure cargo 1105, since net 1101 may be adaptable for use with a variety of storage containers 108 having different dimensions, is light weight, and is easy to transport. For example, if net 1101 is undersized, net 1101 may have some give and be stretchable to cover open end 1131. If net 1101 is oversized, net 1101 may loosely cover open end 1131.

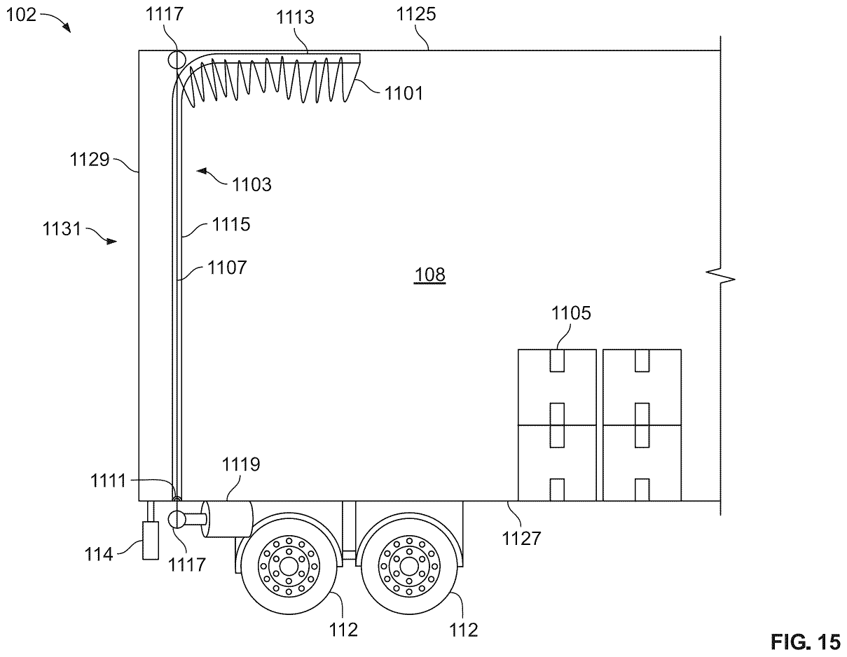

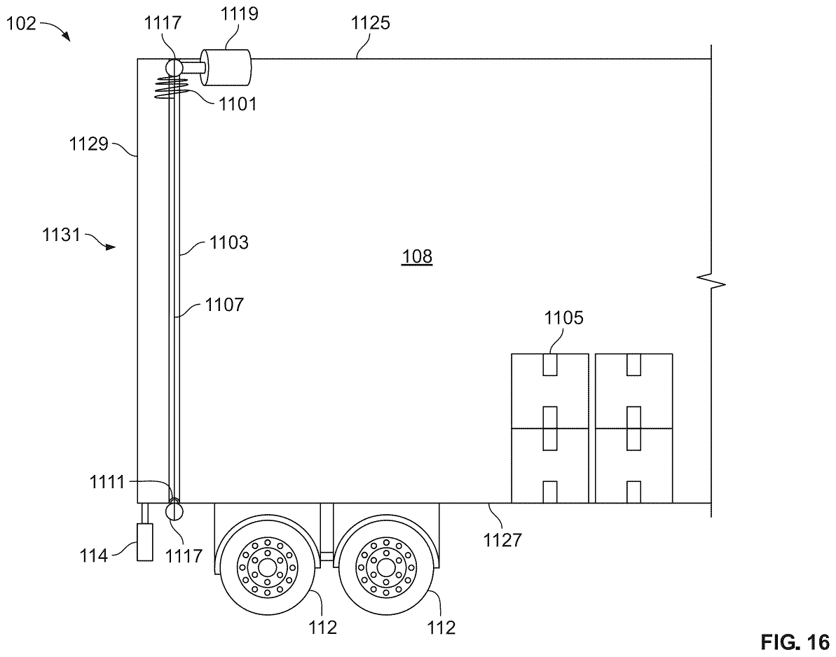

The peripheral edges 1106 of net 1101 may be located in a slot provided in guide rails 1103, such that as net 1101 is moved between a retracted position and a deployed position, net 1101 spans the width of storage container 108 suspended between guide rails 1103. A top edge 1102 of net 1101 is secured adjacent to ceiling 1125 and a bottom edge 1104 of net 1101 is movable from ceiling 1125 to floor 1127. The top peripheral edge 1102 of net 1101 may be secured to ceiling 1125 using conventional fastening members. In this way, when net 1101 is in the deployed position (shown in FIG. 13), net 1101 spans opening 1131 in trailer 102 and thereby prevents cargo 1105 from falling out, even when doors 116 are open or closed and not locked and held stationary. In some embodiments, a cable 1107 may fully or partially be disposed in each of guide rails 1103. Cables 1107 may extend through guide rails 1103 and be attached to a bottom edge 1104 of net 1101. Cables 1107 may be supported by a pulley and selectively be retracted by a motor system (shown in FIGS. 15 and 16) to thereby selectively move net 1101 between the retracted position near trailer ceiling 1125 and the deployed position, whereby lower net edge 1104 is located proximate trailer floor 1127. In this way one end of each cable 1107 may be fixed to the lower periphery 1104 of net 1101 while the opposite end of cable 1107 is attached to a motor or other system that serves to collect the cable and thereby raise net 1101 until it is collected proximate ceiling 1125. In some embodiments, guide rails 1103 may be formed in the sidewalls 1129 of trailer 102.

In some embodiments, one or more weights 1109 may be attached to a bottom edge 1104 of net 1101. Weights 1109 serve to bias net 1101 as net 1101 is extended to the deployed position. In such embodiments, a quick release mechanism (not shown), for example a latch or pin which holds net 1101 in place, may be used to retain net 1101 in the retracted position, near ceiling 1125 until net 1101 needs to be deployed. In some embodiments, the quick release mechanism may be cam buckle or a ratchet tie with a strap wrapped around net 1101, when a toggle latch or pin is actuated, the cam buckle or ratchet tie releases the strap allowing net 1101 to be deployed. When net 1101 is deployed, the quick release mechanism is released and net 1101 drops quickly, in a controlled manner to assume the previously described deployed position. In some embodiments, weights 1109 bias net 1101 towards floor 1127 when the release mechanism is actuated. In some embodiments, the quick-release mechanism (not shown) may be replaced or supplemented by cable 1107, pulley (not shown), and motor system discussed herein. In such systems, net 1101 may be retained in place by cable 1107. In some embodiments, cable 1107 and pulley are able to be disengaged from the motor system to allow the pulley to spin freely. As a result, the free spinning pulley enables net 1101 and cable 1107 to be biased to the deployed position by weights 1109. Once net 1101 is in the deployed position the pulley is reengaged by the motor securing cable 1107 and net 1101 in place. The motor may then be used to move net 1101 back into the retracted position near trailer ceiling 1125.

In some embodiments, a latch 1111 may be positioned adjacent to a bottom edge of each of guide rails 1103 proximate underride guard 114 and floor 1127. When net 1101 is moved into the deployed position, a bottom edge 1104 of net 1101 is engaged by latch 1111, releasably securing net 1101 in the deployed position. In this way, the bottom edge 1104 of net 1101 is fixed to floor 1127 preventing cargo 1105 located behind net 1101 from being displaced through opening 1131 and lost. In some embodiments, latch 1111 may be a toggle latch, a press-to-fit connector, a magnet or electromagnet, or another mechanism for securing an edge of net 1101 adjacent to a ceiling 1125 or floor 1127 of trailer 102.

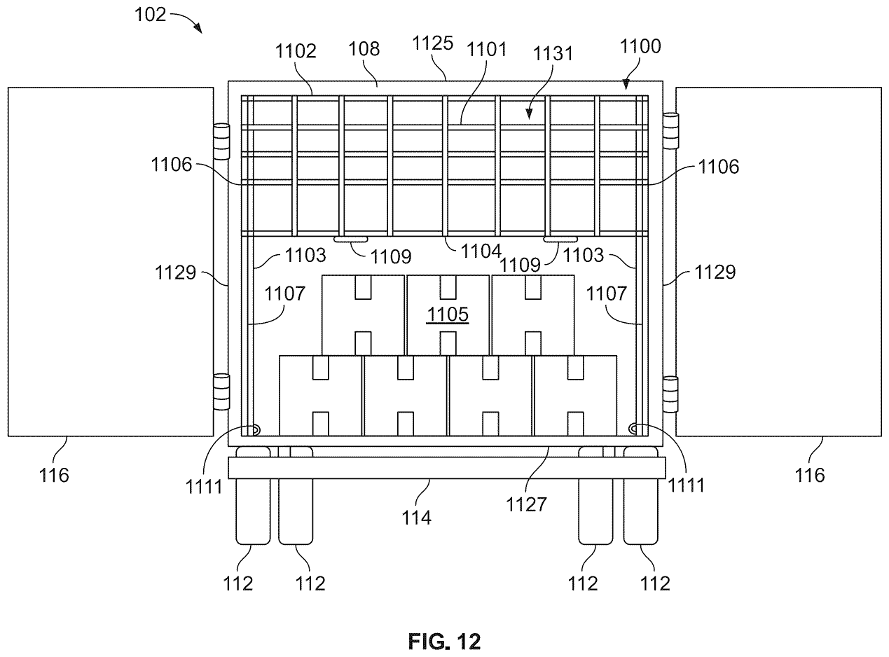

FIG. 12 is the back of a trailer 102 with lost cargo prevention system 1100 in a partially deployed position installed in trailer 102, according to some embodiments. FIG. 12 depicts net 1101 being moved between the retracted position, retained on ceiling 1125, and the deployed position, spanning open end 1131. As net 1101 is moved between the retracted position to the deployed position, net 1101 is unfurled. The peripheral edges 1106 of net 1101 are disposed in guide rails 1103 to span net 1101 across opening 1131 of trailer 102. By disposing the peripheral edges 1106 of net 1101 in guide rails 1103, the system 1100 prevents net 1101 from becoming tangled as net 1101 is moved between the retracted to the deployed orientations.

FIG. 13 is the back of a trailer 102 with lost cargo prevention system 1100 in a deployed position installed in storage container 108, according to some embodiments. Once net 1101 is moved into the deployed position, a bottom edge of net 1101 may be secured in place along the bottom edge of storage container 108 by latch 1111. In some embodiments, net 1101 is secured on all peripheral sides when in the deployed position, with a top edge 1102 of net 1101 is secured adjacent to ceiling 1125 of trailer 102, the sides 1106 of net 1101 are secured to a respective guide rail 1103, and bottom edge 1104 of net 1101 is secured adjacent to floor 1127 of trailer 102. In some embodiments, the bottom edge 1104 of net 1101 is secured to the floor 1127 by latch 1111, cables 1107, weights 1109, or a combination thereof. In this way, net 1101 extends across the open end 1131 of trailer 102 and is secured along the edges 1102, 1104, 1106 of net 1101 thereby impeding movement of cargo 1105 out of trailer 102.

In some embodiments, a processor or control system, for example autonomy computing system 200, may be in communication to the motor system (shown in FIGS. 15 and 16), latches 1111, or other actuatable component of lost cargo prevention system 1100 to selective deploy or retract net 1101 as desired. When autonomous vehicle 100 determines cargo 1105 has been lost or is otherwise unsecured, for example sensors 110 and the perception and understanding module 236 detecting or perceiving cargo 1105 is no longer secured, behaviors and planning module 238 may deploy and retract net 1101 as desired.

FIGS. 14A-C show various designs of net 1101, according to some embodiments. FIG. 14A shows net 1101 in a braided net arrangement with rope forming net 1101 knotted/tied together to form a lattice. FIG. 14B shows net 1101 in a sewn strap arrangement with straps forming net 1101 overlaid and sewn together. FIG. 14C shows net 1101 in a woven net arrangement with the rope forming net 1101 woven together.

FIGS. 15 and 16 show internal side views of trailer 102 with a lost cargo prevention system 1100, according to some embodiments. In some embodiments, guide rail 1103 may have a horizontal section 1113 parallel to ceiling 1125 of trailer 102 for storing net 1101 when net 1101 is in the retracted position and a vertical section 1115 for retaining net 1101 when net 1101 is in the deployed position. The vertical section 1115 of guide rail 1103 may be parallel to the open end 1131 of trailer 102 and extends between trailer floor 1127 and ceiling 1125. Net 1101 may be moveable between the retracted position where it is gathered along the horizontal section 1113, and the deployed position where the displacement of net 1101 is guided along rail vertical section 1115 by cable 1107. In some embodiments, net 1101 is retained on an upper portion of guide rail 1103 when net 1101 is in the retracted position with net 1101 being stored in an accordion configuration when in the retracted position. Net 1101 may be moveable between the retracted position on the upper portion of guide rail 1103 and the deployed positon along the length of guide rail 1103 by cable 1107.

Cable 1107 is operably supported by one or more pulleys 1117 which are driven by a motor 1119. As motor 1119 is actuated in a first direction, cable 1107 is moved along the one or more pulleys 1117. Net 1101, attached to cable 1107, is moved from the retracted position into the deployed position. As motor 1119 is actuated in a second direction, cable 1107 is moved along the one or more pulleys 1117 and net 1101, attached to cable 1107, is moved from the deployed position into the retracted position.

In some embodiments, motor 1119 may be positioned adjacent to the one or more pulleys 1117 or may be operable connected to the one or more pulleys by a drive train. In some embodiments, motor 1119 may be external to storage container 108, for example on the undercarriage of trailer 102, or internal to storage container 108, for example on floor 1127 or ceiling 1125 of trailer 102. In some embodiments, motor 1119 may have a variable speed and a variable torque. In this way motor 1119 may be used to quickly move net 1101 between the retracted and deployed position and may be able to dislodge net 1101 when moving between retracted and deployed position. For example, while motor 1119 is lowering net 1101 into the deploy position, net 1101 may get caught on the corner of cargo 1105, motor 1119, sensing tactile feedback that net 1101 is caught, may reduce angular speed and increase torque to forcibly move net 1101 into the deployed position.

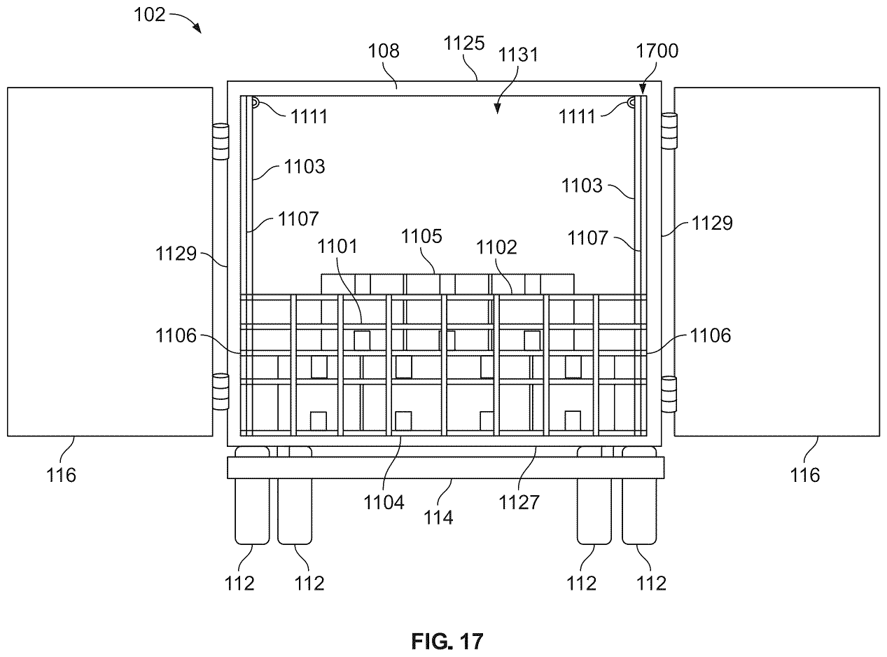

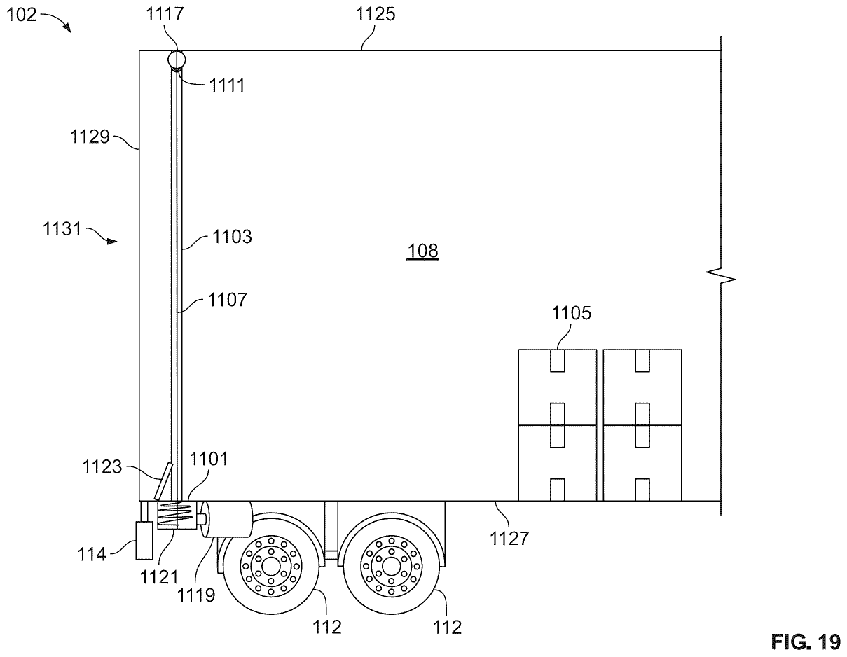

FIG. 17 is the back of a trailer 102 with a lost cargo prevention system 1700 in a partially deployed position, according to some embodiments. In some embodiments, net 1101 is raised up, as opposed to lowered, when being moved from the retracted position into the deployed position. For example, net 1101 may be stored in a compartment (shown in FIG. 19) under storage container 108 when in the retracted position. A top edge 1102 of net 1101 may be attached to cable 1107 and raised from floor 1127 to ceiling 1125 of trailer 102. The top edge 1102 of net 1101 may then be secured to latches 1111 with net 1101 covering the open end 1131 of trailer 102.

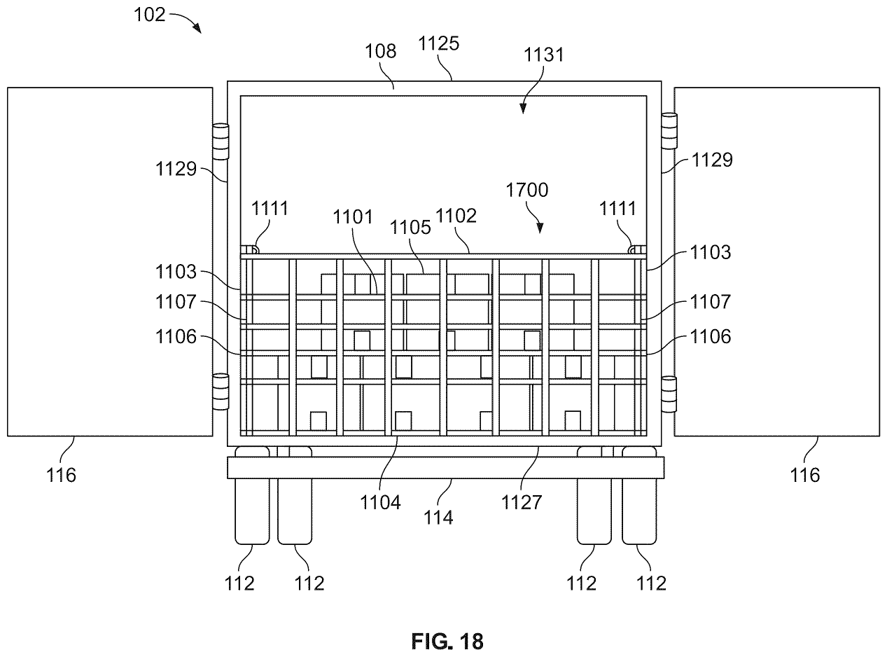

FIG. 18 is the back of a trailer 102 with a lost cargo prevention system 1700 in a deployed position, according to some embodiments. In some embodiments, guide rails 1103 may extend a partial length of the height of storage container 108. For example, guide rails 1103 may extend from floor 1127 to a midpoint along the height of storage container 108. In this way, when net 1101 is in the deployed position and secured to latches 1111, a user may still be able to access the interior of storage container 108 and cargo 1105. In such embodiments, the lost cargo prevention system 1700 may utilize a smaller net 1101 since net 1101 spans a partial area of open end 1131 of trailer 102. Having a smaller net 1101 may be desirable depending of storage space and weight limitations, in particular in embodiments where net 1101 is made of a heavier material such as steel cabling.

FIG. 19 is an internal side view of trailer 102 with a lost cargo prevention system 1700, according to some embodiments. In such embodiments, where net 1101 is raised as opposed to lowered when moved from the retracted position to the deployed position, a compartment 1121 may be positioned below guide rails 1103 for storing net 1101 in the retracted position. In some embodiments, compartment 1121 may be external to storage container, for example on the undercarriage of trailer 102. A lid 1123 may cover the compartment 1121 and form a flush surface with floor 1127 of the trailer 102 when lid 1123 is in a closed position. In some embodiments, when net 1101 is moved from the retracted position into the deployed position, net 1101 may push lid 1123 out of the way into an open position. When net 1101 is moved from the deployed position into the retracted position, net 1101 may be stored in compartment 1121 and lid 1123 moves into the closed position. In some embodiments, the weight of lid 1123 may bias lid 1123 into the closed position. In some embodiments, when lid 1123 is in the open position, lid 1123 may act as a brace against the bottom of net 1101.

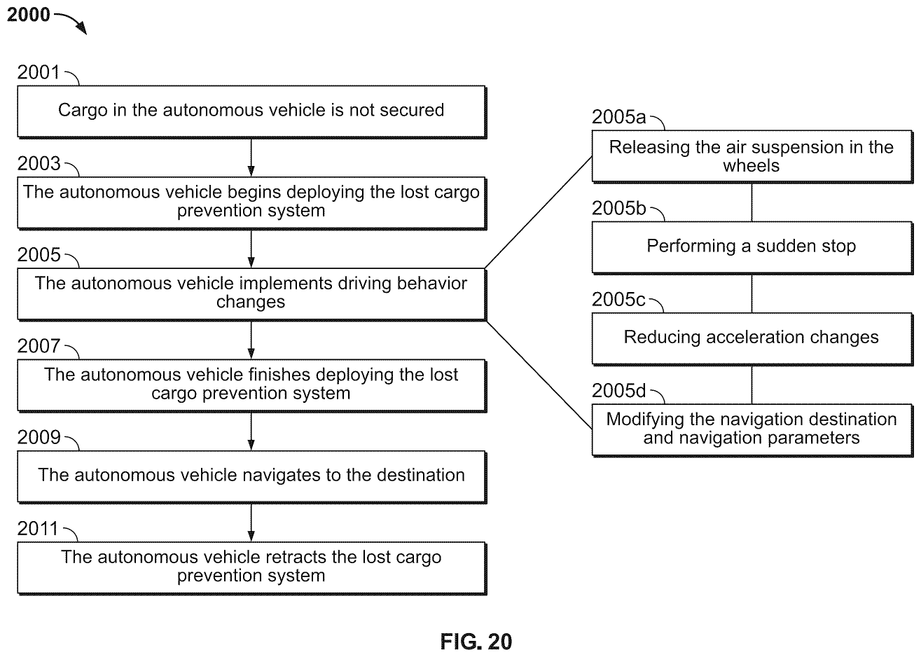

FIG. 20 is a flow chart of a method 2000 for operation of an autonomous vehicle 100 with a lost cargo prevention system 1100, 1700, according to some embodiments. At 2001 an autonomous vehicle 100 detects that the cargo 1105 being transported is not secure, for example boxes or crates falling out of the back of the trailer 102 or detecting that the doors 116 are no longer closed. The autonomous vehicle 100 may detect that some of the cargo 1105 has been lost using a variety of methods. For example, a location module secured to a piece of cargo 1105 geo-fenced to the autonomous vehicle 100, a sensor 110, for example a rear facing camera 214, mounted on the trailer 102 detecting the cargo 1105, or the perception and understanding module 236 detecting a change in the center of mass of the trailer 102, a change in the speed of the autonomous vehicle 100, or a change in the momentum of the autonomous vehicle 100, although not limited thereto. In some embodiments, the perception and understanding module 236 uses one or more of the aforementioned factors when determining if cargo 1105 is lost.

Once the autonomous vehicle 100 has determined that the cargo 1105 is no longer secured, at 2003, the autonomous vehicle begins deploying the lost cargo prevention system 1100, 1700, by moving the net 1101 from the retracted position into the deployed position. Subsequently or simultaneously at 2005 the autonomous vehicle 100 implements driving behavior changes to protect the cargo 1105, since the cargo 1105 is not secured there is a higher likelihood that the cargo 1105 will be lost. To reduce the risk of losing the cargo 1105, the autonomous vehicle may implement one or more of the following: at 2005a the suspension in the rear wheels 106b may be released and the suspension in the rear wheels 112 may be increased to thereby tilt the trailer 102 downward toward the cabin 104; at 2005b the autonomous vehicle 100 may make a sudden stop to shift the cargo to the back of the trailer 102 depending on the road conditions and surrounding vehicles; at 2005c the behavior and planning module 238 may reduce the speed and acceleration changes of the autonomous vehicle 100; and at 2005d the autonomous vehicle 100 may be rerouted to a closer destination and to avoid steep or winding roads, for example roads with a gradient or a curvature above a predetermine threshold value. In some embodiments, the predetermined threshold value for the gradient or curvature of roads to avoid is based on the cargo being transported or recommendations from government agencies, for example, departments of transportation. In some embodiments, the behavior changes 2005a-d may be performed in any order or combination as desired or necessary to prevent loss of the cargo 1105.

At 2007 the lost cargo prevention system 1100, 1700 is finished being deployed. In some embodiments, a leading edge of the net 1101 is secured to one or more latches 1111 when the lost cargo prevention system 1100, 1700 is finished being deployed. In some embodiments, the autonomous vehicle 100 driving behavior changes at 2005 are used to assist the lost cargo prevention system 1100, 1700 being deployed. For example, the cargo 1105 may have shifted during travel and be obstructing the path of the net 1101. In such instances, tilting the trailer 102 at 2005a or performing a sudden stop to shift the cargo 1105 at 2005b may facilitate deployment of the net 1101. In some embodiments, the motor 1119 sensing tactile feedback that the deployment path of the net 1101 is obstructed, may reduce angular speed and increase torque to forcibly move the net 1101 into the deployed position.

At 2009, the autonomous vehicle 100 with the deployed the lost cargo prevention system 1100, 1700 navigate to the destination. In some embodiments, the destination is the original destination or is a destination as modified at 2005d. For example, the original destination may require the autonomous vehicle 100 to travel on a steep uphill road and there are either no alternative route or the alternative routes are not accessible or practical. In such instances, the behavior and planning module 238 may route the autonomous vehicle to a closer hub or another secure location to wait for service personnel to secure the trailer 102 and cargo 1105.

At 2011, once the autonomous vehicle 100 has arrived at the destination, the lost cargo prevention system 1100, 1700 may be retracted. In some embodiments, the autonomous vehicle 100 is able to retract the lost cargo prevention system 1100, 1700, for example actuating the motor 1119 in a second direction opposite the deployment direction. In some embodiments, service personnel may be necessary to retract the lost cargo prevention system 1100, 1700, for example the lost cargo prevention system 1100, 1700 may use a quick release mechanism and weights 1109 to bias the net 1101 into the deployed position without an automatic retraction mechanism.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. A method for protecting cargo with an autonomous vehicle, the method comprising:
detecting that a portion of the cargo has fallen out of the autonomous vehicle and designating the portion of the cargo has fallen out of the autonomous vehicle as lost cargo and the cargo still in the autonomous vehicle as remaining cargo.

2. The method of claim 1, further comprising gathering one or more data points about the lost cargo using one or more sensors connected to the autonomous vehicle; and
transmitting the one or more data points associated with the lost cargo to one or more third parties.

3. The method of claim 2, wherein the one or more data points associated with the lost cargo represents one or more of the following:
a date and time the lost cargo fell out of the autonomous vehicle;
a GPS position of the lost cargo;
a relative position of the lost cargo on a roadway;
a size and quantity of the lost cargo;
a contents of the lost cargo; and
a value of the lost cargo.

4. The method of claim 3, wherein the one or more data points associated with the lost cargo further comprises data identifying current and anticipated ambient conditions where the lost cargo is located, the data identifying current and anticipated ambient conditions comprising:
weather data;
visibility data;
traffic data; and
road condition data.

5. The method of claim 2, wherein transmitting the one or more data points associated with the lost cargo to one or more third parties further comprises:
determining a relevance interval of each of the one or more data points associated with the lost cargo;
comparing each relevance interval to a threshold value associated with each of the one or more third parties; and
determining which of the one or more data points associated with the lost cargo to be transmitted to each of the one or more third parties based on the comparison of the relevance interval of each of the one or more data points associated with the lost cargo and the threshold value associated with each of the one or more third parties.

6. The method of claim 5, wherein when the relevance interval of the data point associated with the lost cargo exceeds the threshold value associated with the third party, the data point associated with the lost cargo is transmitted to the third party.

7. The method of claim 1, further comprising rerouting and navigating the autonomous vehicle to the lost cargo.

8. The method of claim 7, further comprising implementing one or more driving behavior changes to the autonomous vehicle before rerouting the autonomous vehicle to the lost cargo;
wherein the one or more driving behavior changes comprises one or more of:
reducing a speed change of the autonomous vehicle;
reducing an acceleration change of the autonomous vehicle;
routing the autonomous vehicle to avoid roads with a predetermined gradient or curvature;
releasing suspension in one or more wheels of the autonomous vehicle; and
performing a sudden stop to move the remaining cargo within the autonomous vehicle.

9. The method of claim 1, further comprising implementing one or more traffic safety measures with the autonomous vehicle after the autonomous vehicle navigates to the lost cargo.

10. The method of claim 9, wherein the one or more traffic safety measures comprises one or more of:
turning on hazard lights on the autonomous vehicle;
deploying a safety cone; and
angling the autonomous vehicle to direct traffic away from the lost cargo.

11. A method for operating a lead autonomous vehicle and a follow up autonomous vehicle for protecting cargo, the method comprising:
detecting that a portion of the cargo has fallen out of the lead autonomous vehicle and designating the portion of the cargo has fallen out of the lead autonomous vehicle as lost cargo and the cargo still in the lead autonomous vehicle as remaining cargo;
gathering one or more initial data points associated with the lost cargo using one or more sensors connected to the lead autonomous vehicle;
transmitting the initial data points associated with the lost cargo to one or more third parties and the follow up autonomous vehicle;
rerouting and navigating the lead autonomous vehicle to a secure location;
transmitting a request to the follow up autonomous vehicle to protect the lost cargo;
rerouting and navigating the follow up autonomous vehicle to the lost cargo;
implementing one or more traffic safety measures with the follow up autonomous vehicle after the follow up autonomous vehicle navigates to the lost cargo.

12. The method of claim 11, further comprising gathering one or more follow up data points associated with the lost cargo using one or more sensors connected to the follow up autonomous vehicle.

13. The method of claim 12, further comprising comparing the initial data points associated with the lost cargo to the follow up data points associated with the lost cargo;
generating verified data points about the lost cargo based on the comparison of the initial data points associated with the lost cargo to the follow up data points associated with the lost cargo;
generating updated data points associated with the lost cargo based on the comparison of the initial data points associated with the lost cargo to the follow up data points associated with the lost cargo; and
transmitting the verified data points and the updated data points to the one or more third parties.

14. The method of claim 13, wherein the verified data points and the updated data points have an indicator that the verified data points and the updated data points were verified or updated by the follow up autonomous vehicle.

15. The method of claim 13, wherein the verified data points and the updated data points have a timestamp of when the follow up data points used to generate the verified data points and the updated data points were gathered by the follow up autonomous vehicle.

16. The method of claim 11, wherein the request to the follow up autonomous vehicle to protect the lost cargo is transmitted by the lead autonomous vehicle using a vehicle to vehicle communication protocol.

17. The method of claim 11, wherein the request to the follow up autonomous vehicle to protect the lost cargo is transmitted by the one or more third parties.

18. The method of claim 11, further comprising implementing one or more driving behavior changes to the lead autonomous vehicle before rerouting the lead autonomous vehicle to the secure location.

19. The method of claim 18, wherein the one or more driving behavior changes comprises:
reducing a speed change of the lead autonomous vehicle;
reducing an acceleration change of the lead autonomous vehicle;
routing the lead autonomous vehicle to avoid roads with a predetermined gradient or curvature;
releasing suspension in one or more wheels of the lead autonomous vehicle; and
performing a sudden stop to move the remaining cargo within the lead autonomous vehicle.

20. The method of claim 11, wherein the one or more traffic safety measures comprises:
turning on hazard lights on the follow up autonomous vehicle;
deploying a safety cone; and
angling the follow up autonomous vehicle to direct traffic away from the lost cargo.
